(19) United States
(12) Patent Application Publication
(10) Pub. No.: US 2024/0058831 A1
(43) Pub. Date: Feb. 22, 2024

(54) SYSTEM AND METHOD FOR LAYING FLOORING MATERIAL

(71) Applicant: EASY FLOOR LTD., Zoran (IL)

(72) Inventor: Lior FERDMAN, Zoran (IL)

(21) Appl. No.: 18/030,145

(22) PCT Filed: Oct. 7, 2021
(86) PCT No.: PCT/IB2021/059218

§ 371 Date: Apr. 4, 2023

Related U.S. Application Data
(60) Provisional application No. 63/089,377, filed on Oct. 8, 2020.

(51) Int. Cl. B05B 13/00; E04F 15/12; B05C 1/08

(52) U.S. Cl. CPC B05B 13/005; E04F 15/12; B05C 1/08

(57) ABSTRACT

An automated coating material laying system and method of use, the system including: a floor laying robot (FLR) configured for laying of a coating material on a surface; and a docking station for providing coating materials for use by the FLR wherein the adaptation for laying a coating material comprises detection by the FLR of uneven parts of the surface and determining appropriate application of a coating material to ensure a levelled out coated surface.

### FIELD

The present disclosure relates to a system and method for automatically laying a coating material.

### BACKGROUND

Resinous coatings include a range of different polymer materials, including but not limited to epoxies, urethanes, polyaspartics, methyl methacrylates (MMA), microtopping, micro-cement, decorative overlays, cement screeds, paint, vinyl esters, and other polymer floor coatings. These coating materials are used to coat floor surfaces and also wall surfaces. These types of coatings are favored for their generally seamless finish that is easy to maintain and for the broad range of colors and finishes.

Despite increasing popularity, coating materials remains difficult to apply, requiring specialist teams of workers that perform the many floor laying tasks manually. These tasks include mixing base materials in the correct proportion, pouring of the correct amounts per area, spreading the material to an even thickness across the surface, and ensuring even drying without disturbing the spread material. Despite the expertise of the teams performing the manual laying, the process results in inefficiencies and errors including:
measurement of the materials is not precise;
worker inefficiency due to a short “bucket life” of the coating materials requiring mixing bucket after bucket (often with inconsistent mixtures);
the difficulty of continually moving coating mixture from the material mixing point to the application point, sometimes requiring a dedicated worker;
remixing of the coating material is required every few minutes where parts of the coating materials contain sediment;
the coating mixture is poured and spread manually and may not be even or level;
the exact amount of coating material needed is difficult to calculate;
proper manual cleaning of the applying tools is difficult (since the materials set relatively quickly);
having to walk over already-laid areas with spike-rollers for removing air bubbles or to reach other surfaces, thereby damaging the already-laid areas;
it is difficult to create an even texture across the laid surface;
post-laying smoothing such as with a concrete helicopter results in missed areas and uneven textures;
manual laying results in splashes of coating material onto walls that are extremely difficult to remove.

Several devices are available for assisting in the manual floor laying process, but these generally do not resolve the issue listed above. Floor finishing robots or concrete leveling machine are only suitable for floors that have already been laid. Large scale 3D printers can print objects but are not suited to laying of floors due to the limited area that can be covered by the printer and the inability of the printer to spread out a fluid coating material such as those described herein.

There is therefore a need for a device that will prevent the errors and inefficiencies listed above and automate the floor laying process.

### SUMMARY

The present systems and methods disclosed herein overcome the drawbacks of the prior art by providing an automated floor laying system. The floor laying system includes a mobile floor laying robot (FLR) and a docking station (DS) for filling the FLR with coating materials and for recharging the batteries of the FLR. The FLR may include a mapping sensor for determining the dimensions and shape of the area to be coated. Once mapping has been completed, a mission may be defined using a user interface of the DS describing the area to be coated and the materials to be used for coating. The FLR may then be filled with appropriate materials including materials that are mixed immediately prior to application by the FLR and the coating material may then be laid by the FLR.

It should be appreciated, that the laying of one or more layers of a coating material may be performed autonomously by one or more FLRs without the need for human involvement (aside from configuration and setting up of the FLR). The system as described herein may thus enable:
a reduction in the manpower needed and reduced reliance on skilled manpower for laying of floor coatings;
precise use of coating materials based on computed requirements before starting of the laying process;
no coating material bucket life issues since materials are continually mixed as needed inside the FLR;
evening out of surface gradients as detected by the FLR;
evening out of surface irregularities as detected by the FLR;
automated cleaning of the FLR as part of the automated mission;
removal of bubbles and prevention of damage to already-laid floors using spikes integrated into the wheels of the FLR;
surface finishing and cleaning provided by attachments for the FLR.

In some embodiments, an automated coating material laying system includes: a floor laying robot (FLR) configured for laying of a coating material on a surface; and a docking station configured for filling the FLR with coating materials for use by the FLR for coating the surface. In some embodiments, the configuration for laying a coating material includes detection by the FLR of uneven parts of the surface and determining appropriate application of a coating material to ensure a levelled out coated surface.

In some embodiments, the FLR includes one or more cameras for providing visual data for detection of uneven parts of the surface. In some embodiments, the FLR includes a mapping sensor configured to provide data for performing simultaneous localization and mapping in an area to be coated. In some embodiments, the mapping sensor includes one or more of a LIDAR sensor, ultrasound sensor, laser scanner, laser range finder, RADAR, 3D camera, time of flight sensor, scattered light sensor, 2D camera, ultrasound beacons, optical beacons, radio beacons, laser positioning systems, theodolites, GPS, Ultra-Wide Band (UWB) sensor, optical flow sensor, and a combination of the above.

In some embodiments, the system further includes a coating application assembly (CAA) for distributing and spreading a coating material. In some embodiments, the CAA includes a spreader roller positioned such that an edge side of the spreader roller is near flush with the edge of the FLR for spreading and rolling of coating material against the edges of a surface. In some embodiments, the FLR includes wheels, and the wheels include spikes.

In some embodiments, the coating materials include one or more of: epoxies, urethanes, polyaspartics, methyl methacrylates (MMA), microtopping, micro-cement, primers, sealers, decorative overlays, cement screeds, paint, vinyl esters, polymer floor coatings, and a combination of the above. In some embodiments, the system further includes an attachment mount for attached tools. In some embodiments, the attached tools include one or more of: a roller, a spike roller, serrated squeegee, squeegee, plastering-trowel, magic trowel, concrete helicopter, an ultraviolet (UV) light, a polisher, and a vacuum cleaner.

In some embodiments, the system further includes a charging robot configured for refiling the FLR with coating materials and/or recharging the FLR. In some embodiments, the charging robot is configured to follow the FLR and to refill and/or charge the FLR continually while the FLR is performing surface coating. In some embodiments, the DS is configured for determining a coating route to be followed by the FLR to lay a coating material on the surface in an area. In some embodiments, the DS is further configured for determining one or more of: the coating materials and amounts of coating materials required to be filled into the FLRs, where in the area to start the coating process, when to refill the coating material in the FLR, a coating route for coating around an obstacle, the end point of the coating process, the number of FLRs required, where additional coating materials are needed for leveling out gradients or correcting irregular surfaces, and/or the speed of the FLR in each part of the coating route.

In some embodiments, the coating route includes traversing an area by the FLR while laying a coating material, interspersed with a reverse traversal during which no coating material is laid.

In some other embodiments, a method for laying a coating material on a surface includes providing a floor laying robot (FLR) and docking station (DS); providing a floor coating mission to the FLR; and activating the FLR for completing the floor coating mission. In some embodiments, the method further includes detection by the FLR of uneven parts of the surface and determining appropriate application of a coating material to ensure a levelled out coated surface. In some embodiments, the FLR includes one or more cameras for providing visual data for detection of uneven parts of the surface.

In some embodiments, the method further includes performing simultaneous localization and mapping in an area to be coated by the FLR. In some embodiments, the method further includes distributing and spreading a coating material on the surface by the FLR. In some embodiments, the method further includes spreading and rolling of coating material against the edges of a surface.

In some embodiments, the coating materials include one or more of: epoxies, urethanes, polyaspartics, methyl methacrylates (MMA), microtopping, micro-cement, primers, sealers, decorative overlays, cement screeds, paint, vinyl esters, polymer floor coatings, and a combination of the above. In some embodiments, the method further includes providing on the FLR an attachment mount for attached tools. In some embodiments, the attached tools include one or more of: a roller, a spike roller, serrated squeegee, squeegee, plastering-trowel, magic trowel, concrete helicopter, an ultraviolet (UV) light, a polisher, and a vacuum cleaner.

In some embodiments, the method further includes, by a charging robot, refiling the FLR with coating materials and/or recharging the FLR. In some embodiments, the method further includes, by the charging robot, following the FLR to refill and/or charge the FLR continually while the FLR is performing surface coating. In some embodiments, the method further includes, by the DS, determining a coating route to be followed by the FLR to lay a coating material in an area. In some embodiments, the DS is further configured for determining one or more of the coating materials and amounts of coating materials required to be filled into the FLRs, where in the area to start the coating process, when to refill the coating material in the FLR, a coating route for coating around an obstacle, the end point of the coating process, the number of FLRs required, where additional coating materials are needed for leveling out gradients or correcting irregular surfaces, and/or the speed of the FLR in each part of the coating route. The system of claim 14, wherein the coating route includes traversing an area by the FLR while laying a coating material, interspersed with a reverse traversal during which no coating material is laid.

In some embodiments, the coating route includes traversing an area by the FLR while laying a coating material, interspersed with a reverse traversal during which no coating material is laid.

In some other embodiments, a method for printing a layered resin 3D cuboid includes providing a floor laying robot (FLR); and laying of alternate coating material layers and painting material layers by the FLR to form the cuboid. In some embodiments, the method further includes, by a computing device, analyzing an image to determine a required number and form of coating material layers and painting material layers for laying by the FLR. In some embodiments, the method further includes, laying of a both resin and painting material in a painting material layer by the FLR, wherein the FLR includes two coating application assemblies (CAA), wherein a first CAA lays a clear or partially clear coating material based on a resin, and a second CAA lays an ink or other multicolor material.

In some embodiments, wherein the printing is performed within a frame. In some embodiments, a painting material is painted by a painting tool attached to an attachment mount of the FLR. In some embodiments, one or more layers are cleaned by a cleaning tool attached to an attachment mount of the FLR. In some embodiments, one or more layers are polished by a polishing tool attached to an attachment mount of the FLR. In some embodiments, one or more layers are dried by a drying tool attached to an attachment mount of the FLR.

As used herein the term “coating material” may include all forms of floor or wall coatings applied by the system as disclosed including but not limited to resinous coatings, epoxies, urethanes, polyaspartics, methyl methacrylates (MMA), micro-cement, Microtopping, decorative overlays, cement screeds, paint, vinyl esters, and other polymer coatings as well as the constituent materials mixed to create coating materials. A complete coating process may include one or more of a primer including one or more components (usually based on epoxy or resin), a main coat based on polymers of at least two components, and a top coat including a sealer with one to three components.

While a floor coating process is described herein, it should be appreciated that the system as disclosed may also be used for providing wall coatings. While a floor laying robot is described herein it should be appreciated that the concept can be expanded to include different devices with different capabilities relating to different aspects of coating material application such as mapping robots, paint robots, paint and casting robots, polish robots, grinding robots, print robots, floor-smoothing robots, ultraviolet (UV) robots and so forth.

This Summary is provided to introduce a selection of concepts in a simplified form that are further described below in the Detailed Description below. It may be understood that this Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings.

### BRIEF DESCRIPTION OF THE FIGURES

The disclosure is herein described, by way of example only, with reference to the accompanying drawings. With specific reference now to the drawings in detail, it is stressed that the particulars shown are by way of example and for purposes of illustrative discussion of the preferred embodiments of the present disclosure only and are presented in order to provide what is believed to be the most useful and readily understood description of the principles and conceptual aspects of the disclosure. In this regard, no attempt is made to show structural details of the disclosure in more detail than is necessary for a fundamental understanding of the disclosure, the description taken with the drawings making apparent to those skilled in the art how the several forms of the disclosure may be embodied in practice. The disclosure will now be described in relation to certain examples and embodiments with reference to the following illustrative figures so that it may be more fully understood. In the drawings:

FIGS. 1A-1U show illustrative drawings of an automated floor laying system according to some embodiments;

FIGS. 2A and 2B-2J are respectively a flowchart and illustrative floorplans showing operation of an automated floor laying system according to some embodiments

FIGS. 3A-3D illustrate a method for printing a layered resin 3D floor or wall coating according to some embodiments.

### DETAILED DESCRIPTION

Reference will now be made in detail to non-limiting examples of systems and methods for applying coating materials which are illustrated in the accompanying drawings. The examples are described below by referring to the drawings, wherein like reference numerals refer to like elements. When similar reference numerals are shown, corresponding description(s) are not repeated, and the interested reader is referred to the previously discussed figure(s) for a description of the like element(s).

Aspects of this disclosure may provide a technical solution to the challenging technical problem of applying coating materials and may relate to systems for applying coating materials with the systems having at least one processor (e.g., processor, processing circuit or other processing structure described herein), including methods, systems, devices, and computer-readable media. For ease of discussion, example methods are described below with the understanding that aspects of the example methods apply equally to systems, devices, and computer-readable media. For example, some aspects of such methods may be implemented by a computing device or software running thereon. The computing device may include at least one processor (e.g., a CPU, GPU, DSP, FPGA, ASIC, or any circuitry for performing logical operations on input data) to perform the example methods. Other aspects of such methods may be implemented over a network (e.g., a wired network, a wireless network, or both).

As another example, some aspects of such methods may be implemented as operations or program codes in a non-transitory computer-readable medium. The operations or program codes may be executed by at least one processor. Non-transitory computer readable media, as described herein, may be implemented as any combination of hardware, firmware, software, or any medium capable of storing data that is readable by any computing device with a processor for performing methods or operations represented by the stored data. In a broadest sense, the example methods are not limited to particular physical or electronic instrumentalities, but rather may be accomplished using many differing instrumentalities.

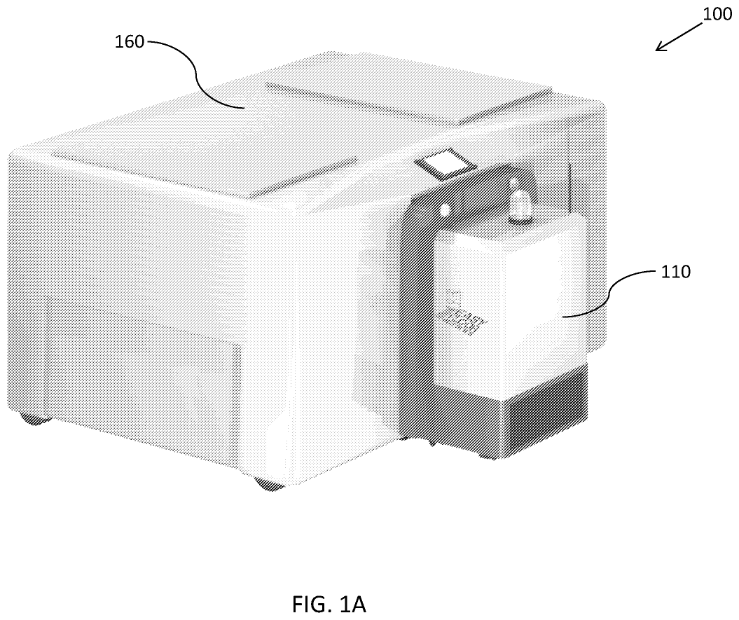

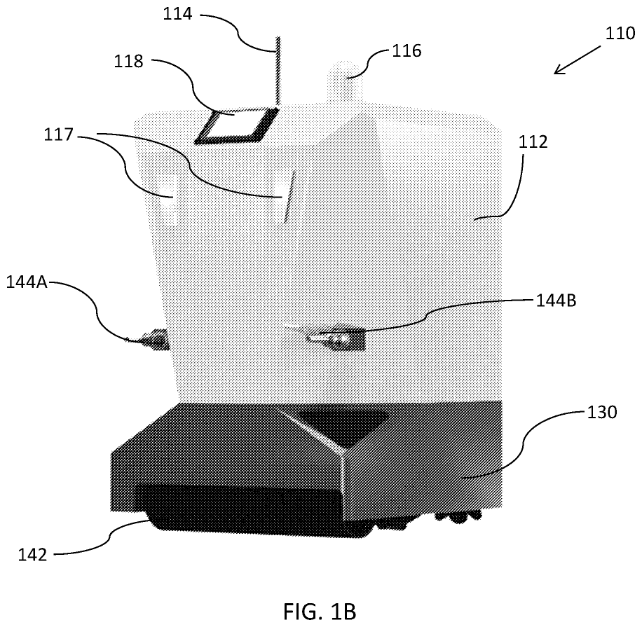

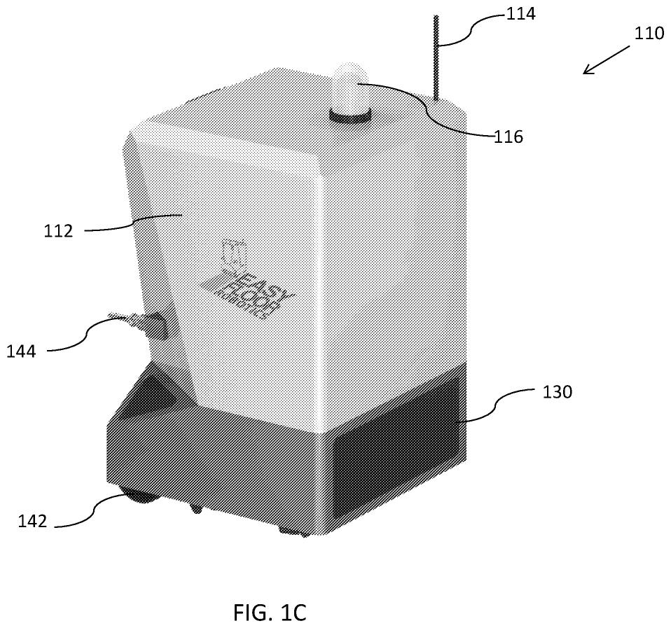

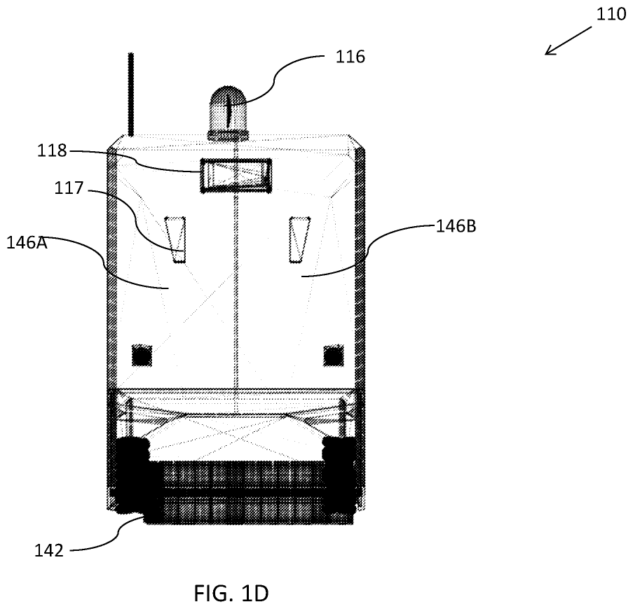

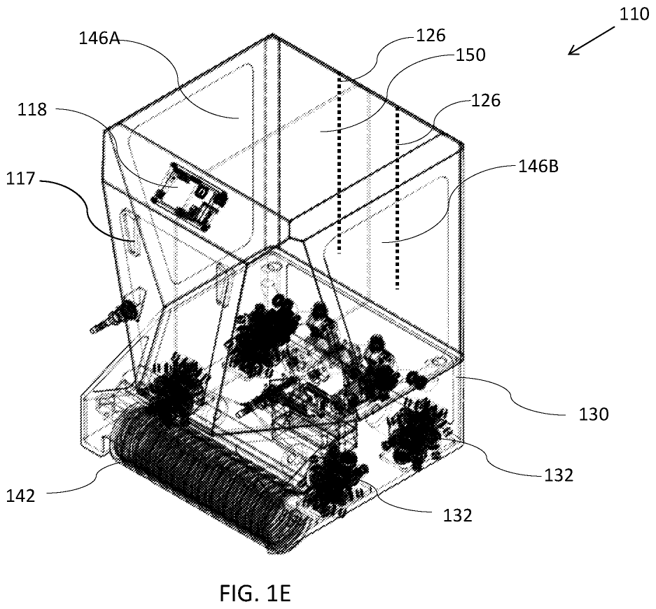

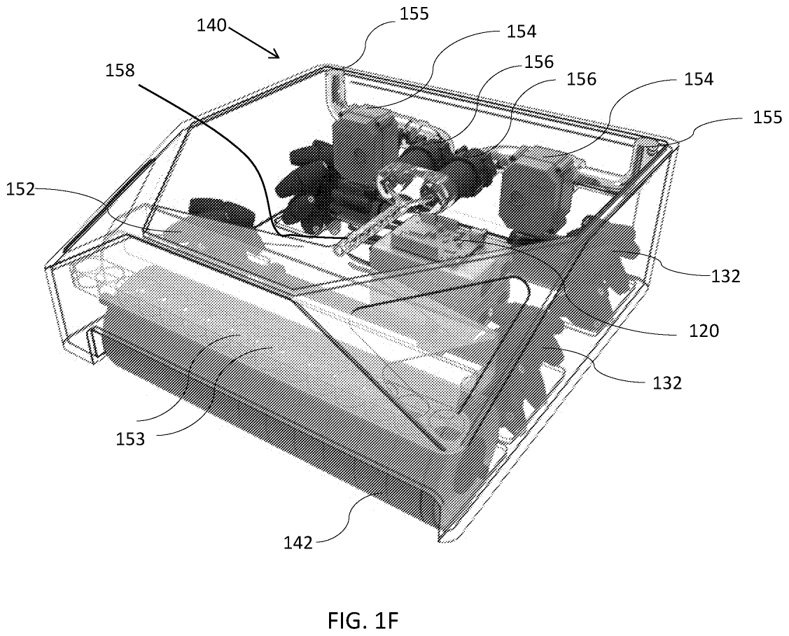

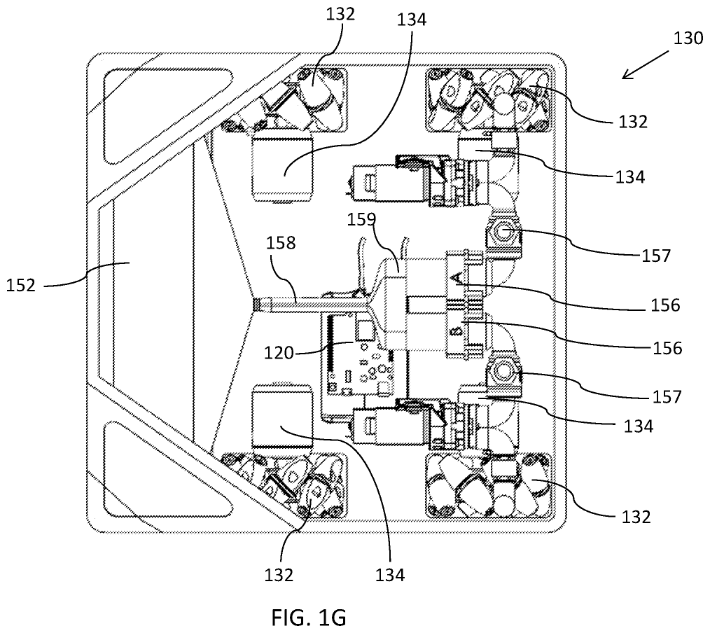

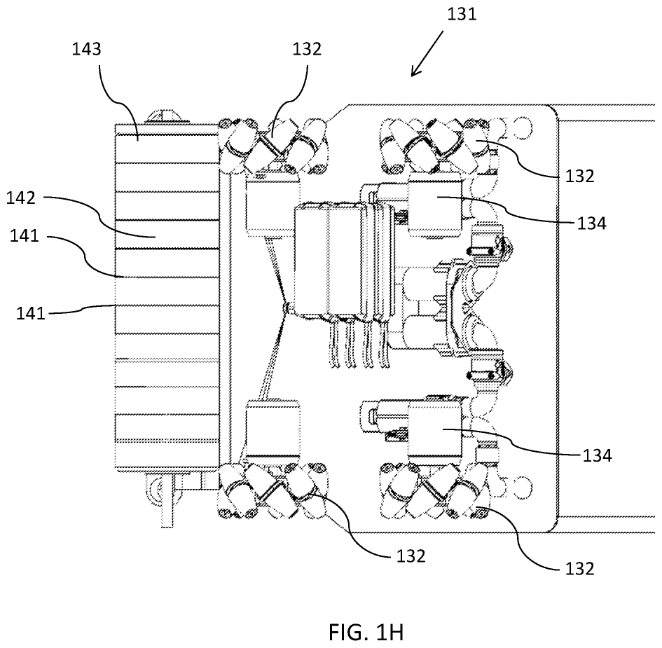

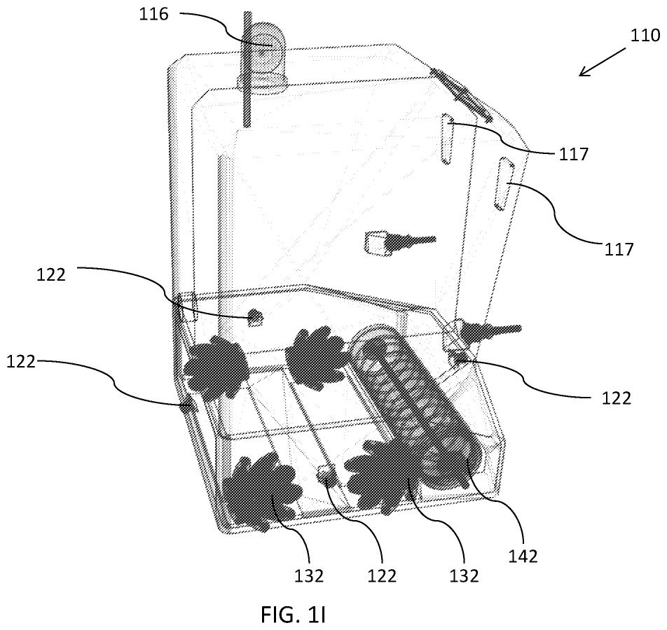

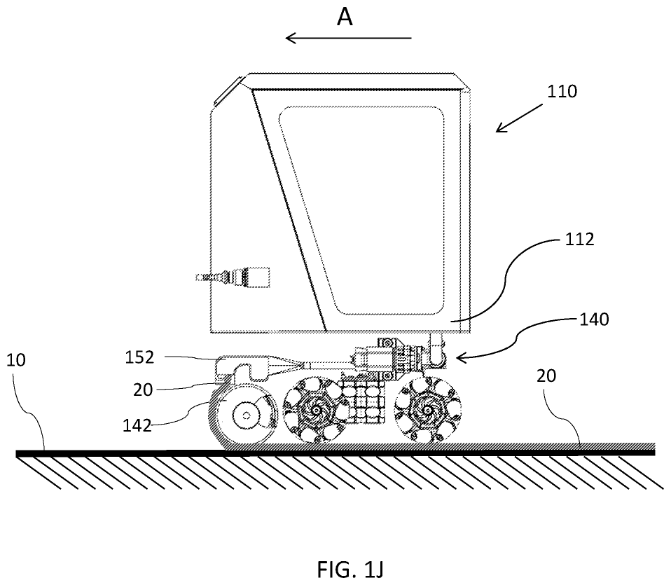

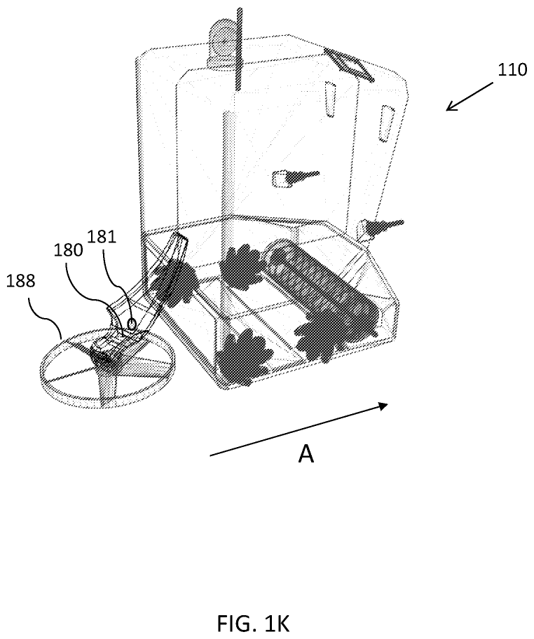

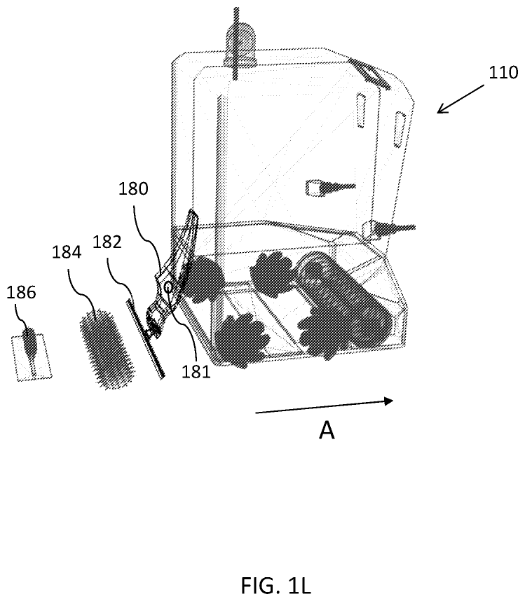

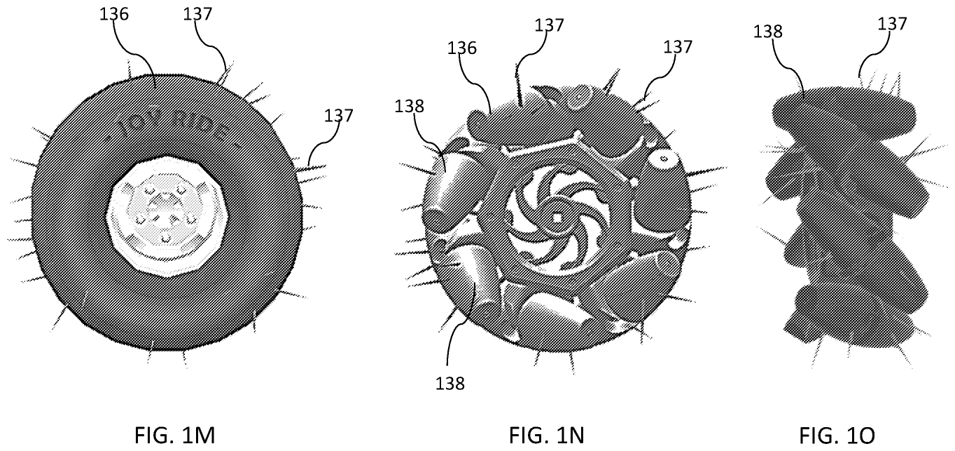

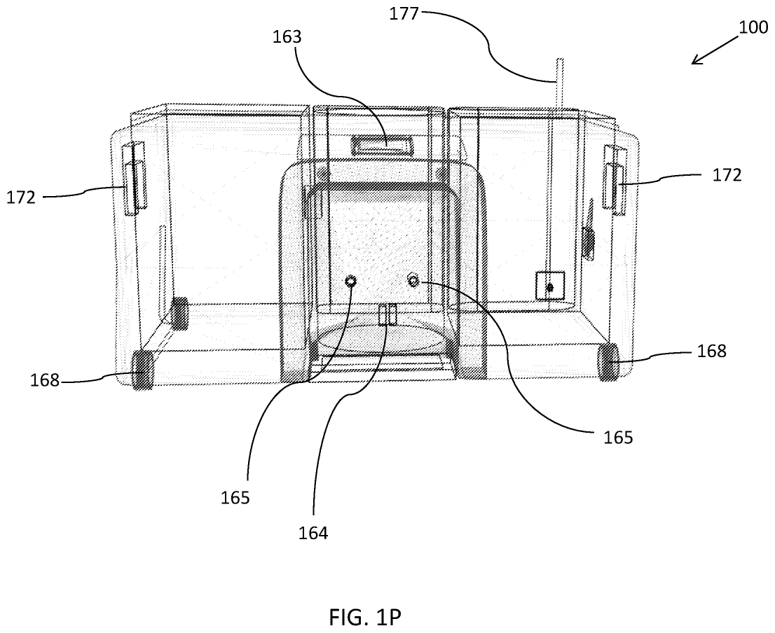

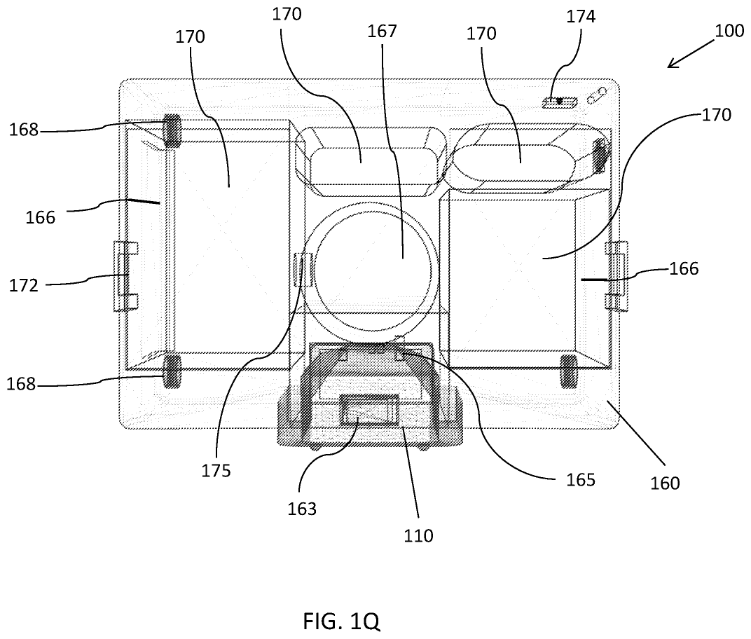

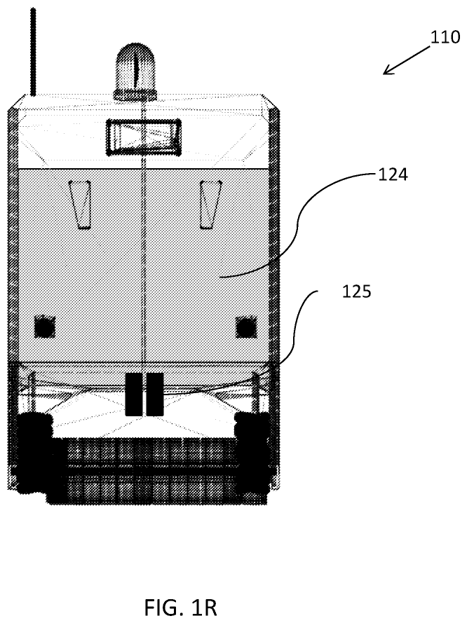

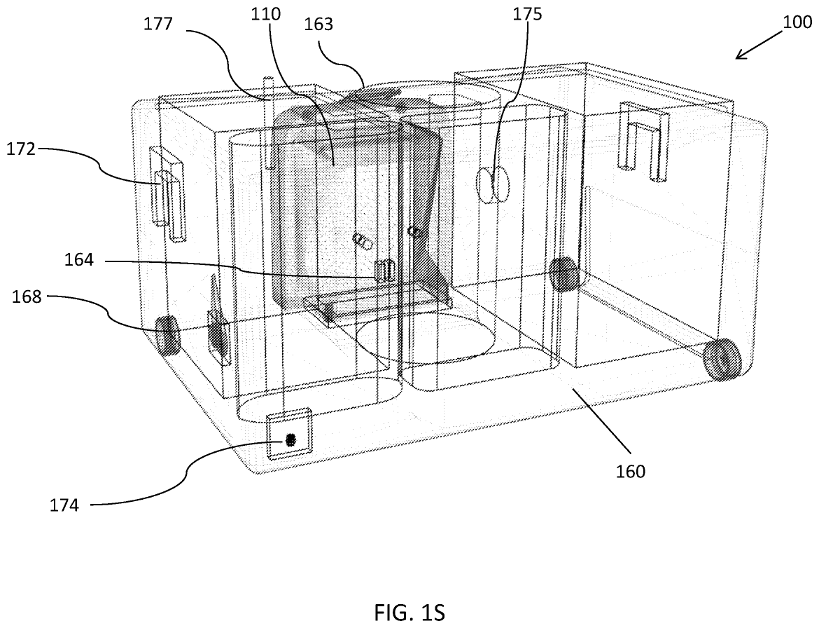

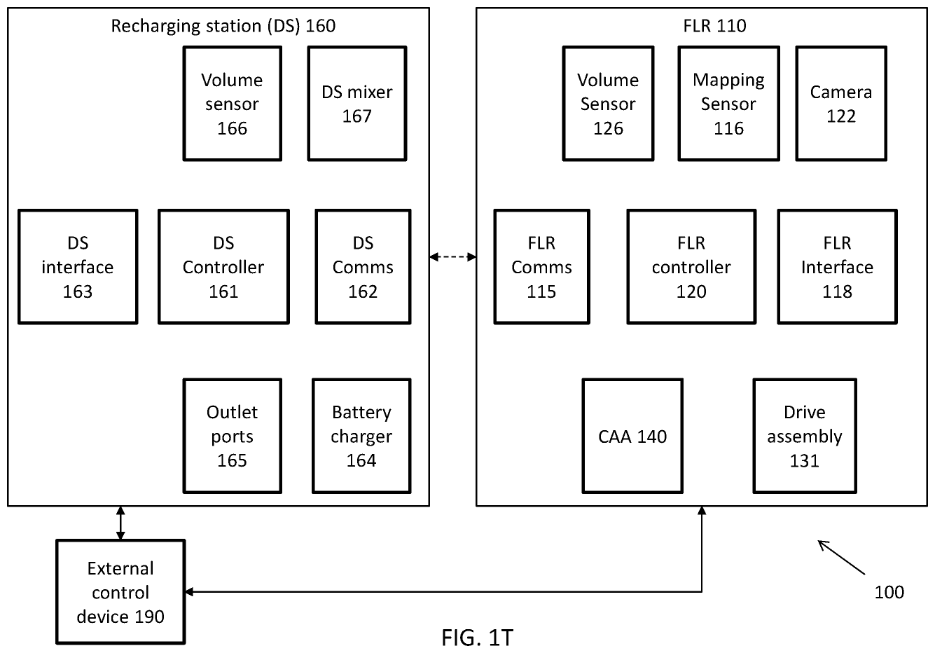

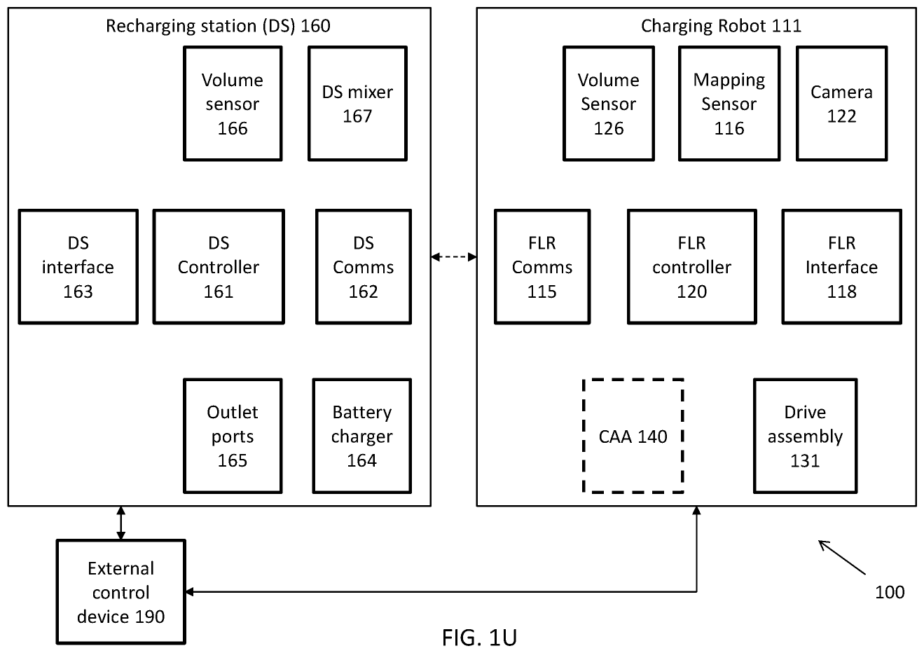

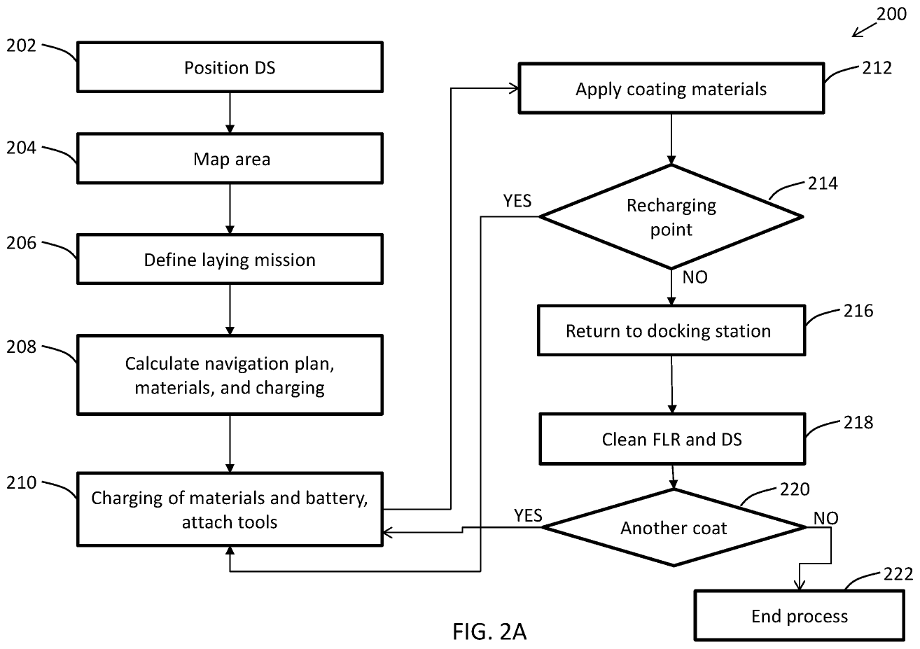

FIGS. 1A-1U show illustrative drawings of an automated floor laying system according to some embodiments. As shown in FIG. 1A a floor laying system 100 may include a floor laying robot (FLR) 110 and a docking station (DS) 160. In some embodiments, system 100 may include a charging robot 111 (FIG. 1U). Where system 100 or FLR 110 or DS 160 or charging robot 111 may be said herein to provide specific functionality or perform actions, it should be understood that the functionality or actions are performed by one or both of an FLR controller 120 and/or a DS controller 161 or charging robot that may call on other components of system 100. Controllers 120 and 161 are computing devices as defined herein and may manage the operation of the components of system 100 and may direct the flow of data between the components of system 100.

As shown in FIGS. 1B-1C FLR 110 may include a storage enclosure 112 enclosing one or more storage tanks 146, and a drive enclosure 130 that may include and enclose one or both of a drive assembly 131 and a coating application assembly (CAA) 140. In some embodiments, a controller interface 118 may be mounted on the outer upper side of storage enclosure 112. In some embodiments, one or both of a mapping sensor 116 and a communications (comms) antenna 114 may be mounted on the outer upper side of storage enclosure 112. In some embodiments, recharging ports 144 may provide for refilling of storage tanks 146 with coating materials. In some embodiments, a light source 117 may provide lighting for mapping sensor 116 and/or cameras 122 (FIG. 11). Although two light sources 117 are shown in specific positions on FLR 110, any suitable number of light sources 117 are optionally provided in any suitable position on FLR 110. Non-limiting examples of light source 117 include an LED, LED array, RGB LED, and so forth.

As shown in FIGS. 1D and 1E, FLR 110 may include one or more storage tanks 146. In FIGS. 1D and 1E two storage tanks 146A and 146B are shown divided by storage partition 150. In some embodiments, more than two storage tanks 146 may be provided. Storage tanks 146 may store one or more coating materials or constituent materials thereof for mixing and/or laying including but not limited to a polymer liquid, quartz, powder, liquid plastic, liquid metal, or other polymers. In some embodiments, storage tanks 146 may be of different sizes depending on the required ratio of materials to be mixed and laid. In some embodiments, storage tanks 146 may hold already-mixed materials. In some embodiments, storage tanks 146 may hold components for mixing by CAA 140. In some embodiments, storage tanks 146 may include volume sensors 126 for detecting the level of coating materials stored therein and in communication with an FLR controller 120 for monitoring of the levels by FLR controller 120. In some embodiments, storage tanks 146 may be filled via filling inlet ports 144 as will be described further below.

In some embodiments, FLR 110 may include one or more batteries 124 for powering FLR 110. In some embodiments, batteries 124 may be recharged via recharging pads 125 when FLR 110 is docked with docking station 160 and recharging pads 125 make contact with battery charger 164. In some embodiments, batteries 124 may be removed from FLR 110 for charging. In some embodiments, batteries 124 may be recharged by connecting FLR 110 to a power source.

As shown in FIGS. 1F-1H, drive enclosure 130 encloses CAA 140 that is attached thereto. CAA 140 includes components for receiving materials from storage tanks 146 and laying these on a surface 10. In some embodiments, two CAAs 140 are provided for simultaneously laying different coating materials where each CAA 140 is fed from a separate storage tank 146. Outlet pipes 155 from storage tanks 146 are in fluid communication with control valves 157 for enabling or disabling flow of coating materials from storage tanks 146 and for preventing backflow of materials into storage tanks 146. In some embodiments, valves 157 may be in fluid communication with pumps 154 that in turn may be in fluid communication with fluid injectors 156. In some embodiments, pumps 154 may pump the coating materials into injectors 156. In some embodiments, CAA 140 may include pressure detectors (not shown) for detecting high pressure in CAA 140 and shutting off CAA 140. In some embodiments, valves 157 may operate alternately such that CAA 140 lays a material from a first tank with a first valve 157 open (and second valve 157 closed) and then switches to a material from a second tank with a second valve 157 open (and first valve 157 closed).

Injectors 156 may inject the coating materials into mixer 159. Mixer 159 may mix coating materials received from injectors 156. In some embodiments, mixer 159 may be one of a passive mixer, a motorized mixer, or a putty mixer. In some embodiments, a single coating material or already-mixed coating material may be fed from storage tanks 146 and no mixing is performed in mixer 159. The output of mixer 159 may be fed into feeder pipe 158 that may feed the coating material into a material distributor 152. Distributor 152 may include distribution ports 153 that may pour the coating material onto spreader roller 142. In some embodiments, distributor 152 may feed the coating material into the inner cylinder of spreader roller 142 such that the coating material may exit spreader roller 142 for application via pores in spreader roller 142. Spreader roller 142 may spread the coating material onto surface 10 to be coated. Spreader roller 142 may include rubber or fabric.

Spreader roller 142 may be positioned such that an edge side 143 is near flush with the edge of drive enclosure 130 for spreading and rolling of coating material against the edges of a surface 10 such as where floor surface 10 meets a wall. In some embodiments, spreader roller 142 may be raised so as not to make contact with surface 10, such as when FLR 110 is in mapping mode or when traveling such as returning to DS 160 for recharging.

Drive enclosure 130 may also enclose a drive assembly 131 attached thereto. Drive assembly 131 may include wheels 132. In some embodiments, as shown in FIGS. 1F-1H, each wheel may be individually powered by a drive motor 134. Use of individual motors may enable fine control of the speed, direction, and turning radius of FLR 110. In some embodiments, fewer motors 134 may be used along with per-wheel transmission (not shown). In some embodiments, fewer or more than four wheels 132 may be provided. Tires 136 may be mounted on wheels 132.

As shown in FIGS. 1M-1O tires may be provided with different characteristics. In some preferred embodiments, tires 136 may include spikes 137 for aerating the laid coating material as tires 136 roll over the coating material without disturbing the finish of the laid coating material or leaving tire prints. In some embodiments (FIGS. 1N-1O), tires may include rows of frusta 138 shaped protuberances laid end to end. In some embodiments, FLR 110 may include tracks (not shown) mounted on wheels 132. Tires 136 and drive motors 134 may be configured to turn a full 90 degrees or more so as to enable rotation “on the spot” or sideways movement of FLR 110.

Drive enclosure 130 may further encloses FLR controller 120 attached thereto. FLR controller 120 is a computer in data communication with components of FLR 110 as shown in FIG. 1T for controlling the movement and coating laying activity of FLR 110. In some embodiments, FLR interface 118 may provide a user interface for interaction with and operation of FLR 110 and system 100. In some embodiments, FLR interface 118 may include a screen and touch panel, or other form of user interface as known in the art.

As shown in FIG. 11 FLR 110 may include a mapping and navigation system that may include cameras 122 and/or mapping sensor 116. In some embodiments, mapping sensor 116 may include one or more mapping sensors including but not limited to: a LIDAR sensor, ultrasound sensor, laser scanner, laser range finder, RADAR, 3D camera, time of flight sensor/camera, scattered light sensor, 2D camera and/or any other suitable mapping sensor. In some embodiments, mapping sensor 116 may include one or more positioning sensors including but not limited to: 2D cameras, ultrasound beacons, optical beacons, radio beacons, laser positioning systems, theodolites, GPS, Ultra-Wide Band (UWB) sensor, optical flow sensor, and/or any other suitable positioning sensor.

Mapping sensor 116 may provide data to FLR controller 120 for performing simultaneous localization and mapping (SLAM) such that the layout and position of items (such as docking station 160) and obstacles in the area to be coated may be determined for planning of floor laying activities and for positioning of FLR 110. Mapping sensor 116may provide data used by controller 120 to measure any gradient changes across surface 10 for determining appropriate application of coating material to ensure a level surface. Cameras 122 may provide visual data used by controller 120 to detect fixed and moving objects that may obstruct the path of FLR 110. Cameras 122 may provide visual data used by controller 120 to further detect uneven parts of surface 10 such as bumps and ridges for determining appropriate application of coating material to ensure a levelled-out surface and even finish. Controller 120 may use machine vision techniques to analyze the visual data provided by mapping sensor 116 and/or cameras 122.

In a non-limiting example, when a ridge is detected in a floor then less coating material is dispensed by the FLR as it goes over the ridge. In a non-limiting example, when a furrow is detected in a floor then more coating material is dispensed by the FLR as it goes over the furrow. In a non-limiting example, where a surface has a gradient, more coating material will be dispensed as the FLR 110 traverses the surface in the direction of increasing height of the gradient to thereby create an even coating across the gradient. In some embodiments, surface irregularities such as bumps, ridges and uneven surfaces are reported to docking station 160 to be used by docking station 160 in the coating route calculation including the amount of material needed to be dispensed by FLR 110 at any given part of the surface and the total amount of material needed taking into account the surface irregularities.

As shown in FIGS. 1K-1L, in some embodiments, FLR 110 may include an attachment mount 180 attached to the rear of FLR 110 for mounting thereto of a range of attachment tools each providing additional functionality. In some embodiments, attachment mount 180 may include control/power connector 181 for providing power to and for controlling attached tools. In some embodiments, attachment mount may be attached to the rear of FLR 110 via a robotic arm (not shown). Non-limiting examples of tools for attachment to mount 180 include a roller for applying more force for attachment of coating to floor or lower layer of coating, a spiked roller 184 for removing air bubbles from coating and for assisting leveling out, serrated squeegee for removing unneeded material and/or texturing and/or for leveling a coating, squeegee, plastering-trowel 182 for leveling the surface, magic trowel 186, concrete helicopter 188 for smoothing, an ultraviolet (UV) light that may be used for drying and/or hardening coating materials, a polisher, a vacuum cleaner, or other device for spreading a coating material, and/or smoothing a coating material after laying, and/or spreading flakes or other granular material such us quartz in order to obtain a desired look or texture. In some embodiments, attachment mount 180 may be telescopic in order to be raised and lowered for bringing the attached tool into different levels of contact with surface 10 or for adjusting the attached tool for such that the tool can perform leveling of a surface (before or after coating).

Charging robot 111 may include all of the components of FLR 110 as described above. In some embodiments, charging robot 111 may be configured for filling FLR 110 with coating material. In some embodiments, filling inlet ports 144 of charging robot 111 may be configured for transferring coating material stored in charging robot 111 to FLR 110. In some embodiments, charging robot 111 may be configured for recharging batteries 124 of FLR 110, for example by making contact between recharging pads 125 of charging robot and similar pads on FLR 110. In some embodiments, filling robot may not include any CAA 140 such as when charging robot 111 is used solely for filling an FLR 110 with coating material and/or charging the batteries 124 of FLR 110.

As shown in FIGS. 1P-1S, docking station (DS) 160 may provide for electric recharging of batteries 124 and refilling of storage tanks 146 with coating materials, cleaning materials, and/or water. Where DS 160 is described herein as interfacing with FLR 110 (such as for refilling or recharging batteries), this should be understood as applying equally to charging robot 111 that has the same interface capabilities to DS 160 as does FLR 110. In some embodiments, DS 160 may be portable to allow for transport to a site for use with FLR 110 for laying a coating material. DS 160 may include DS wheels 168 for enabling moving of DS 160. In some embodiments, DS 160 may include handles 172 for enabling being lifted and positioned by personnel.

DS 160 may include a DS controller 161 for controlling DS 160 as will be described further below. DS 160 may include a DS interface 163 that may provide a user interface for operation of DS 160 and system 100. In some embodiments, DS interface 163 may include a screen and touch panel or other form of user interface as known in the art. FIG. 1T shows components of DS 160 that may be in data communication with DS controller 161.

DS 160 may be powered via an external power input socket 174. DS 160 may include battery charger 164 for charging battery 124 of FLR 110 when FLR 110 is docked in DS 160 such as shown in FIG. 1A and FIGS. 1P-1S.

DS 160 may include DS storage tanks 170. Although four tanks are shown it should be appreciated that any suitable number of DS tanks 170 are provided and the number of tanks shown should not be considered limiting. DS tanks 170 may feed into DS mixer 167 for mixing of components of coating materials. In some embodiments, mixing may be provided in mixer 159 and DS mixer 167 may be replaced by another DS storage tank 170. DS tanks 170 may be in fluid communication with mixer 167 via mixing ports 175 (partially shown). DS storage tanks 170 may store one or more coating materials or constituent materials thereof for mixing and/or laying including but not limited to a polymer liquid, quartz, powder, liquid plastic, liquid metal or other polymers, cleaning materials and/or water. In some embodiments, DS storage tanks 170 may be of different sizes depending on the required ratio of materials to be mixed and laid. In some embodiments, one or more of DS storage tanks 170 may hold already-mixed coating materials. In some embodiments, one or more of DS storage tanks 170 may hold components for mixing by DS mixer 167. In some embodiments, one or more of DS storage tanks 170 may hold cleaning materials and/or water for automated or semi-automated cleaning of DS 160 and/or FLR 110. In some embodiments, one or more of DS storage tanks 170 may be used for storing unused or waste material. In some embodiments, DS storage tanks 170 may include volume sensors 166 for detecting the level of coating materials stored therein and in communication with DS controller 161 for monitoring of the material levels by DS controller 161. DS 160 may include pumps, piping and valves (not shown) for moving stored materials between tanks 170, to DS mixer, 167, and/or to outlet ports 165.

DS mixer 167 (or alternatively one of DS storage tanks 170) may feed mixed coating materials out of material outlet ports 165 that interface with filing inlet ports 144 of FLR 110 when FLR 110 is docked with DS 160. Outlet ports 165 may also be used to suck unused coating materials out of FLR 110 and then inject cleaning materials into FLR 110 to thereby clean FLR 110.

DS 160 may include a communications (comms) unit 162 for data communication with FLR 110 for controlling and/or monitoring FLR 110. Comms unit 162 may be in data communication with DS controller 161. Comms unit may include an antenna 177. In some embodiments, DS 160 may be in data communication with and interface to an external control device 190. In some embodiments, the interface to external control device 190 may be wireless via comms unit 162. Non-limiting examples of an external control device 190 may include a smartphone, laptop or tablet running an app for wirelessly controlling and/or monitoring system 100.

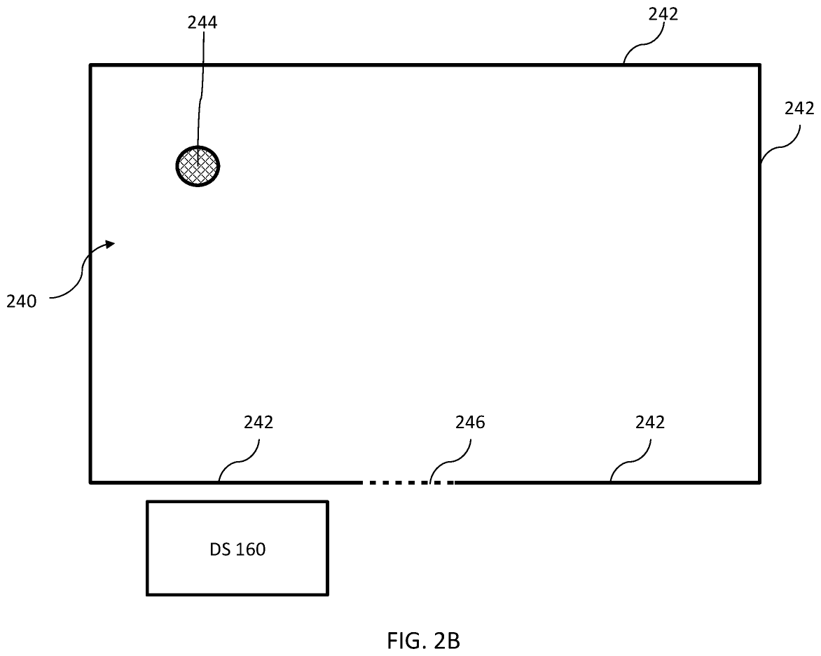

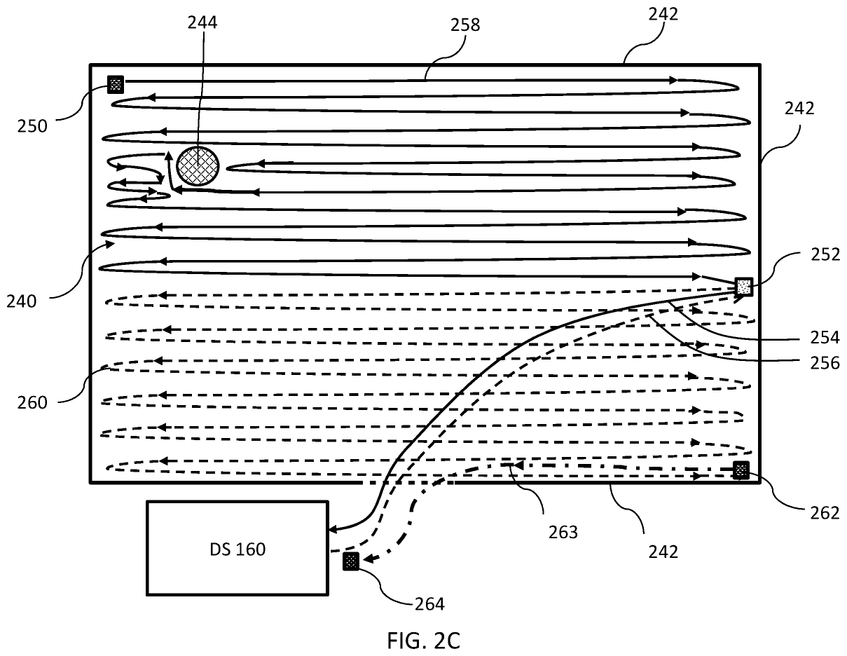

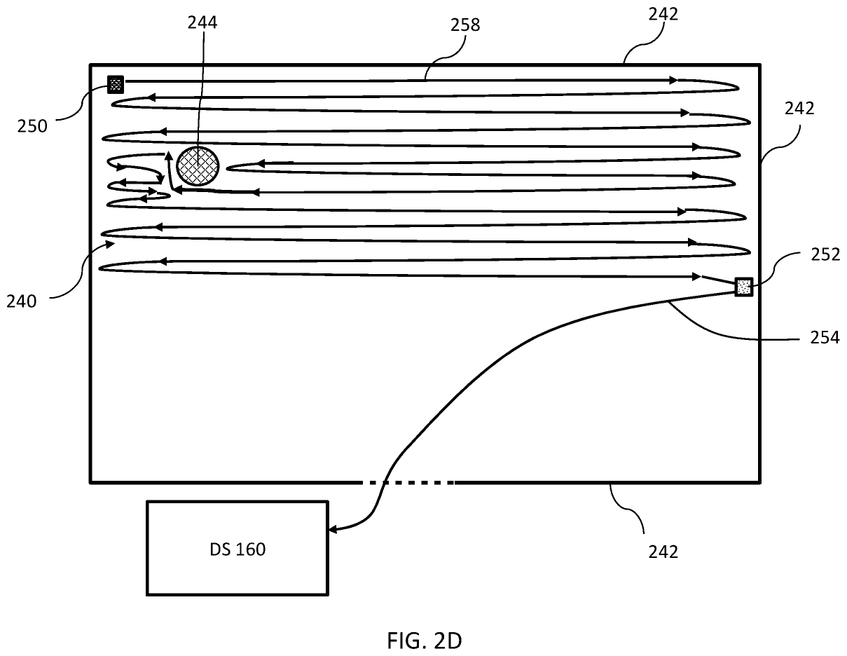

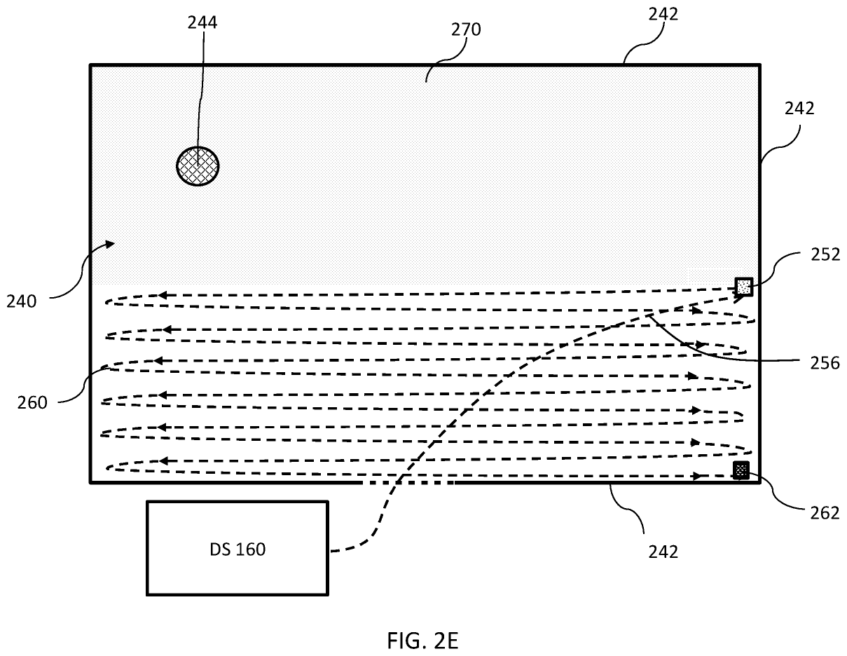

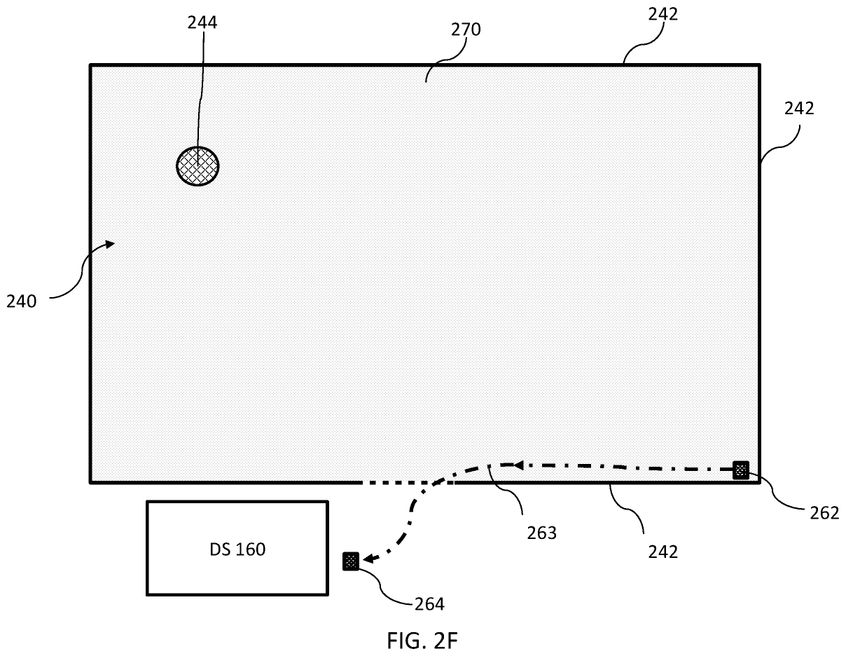

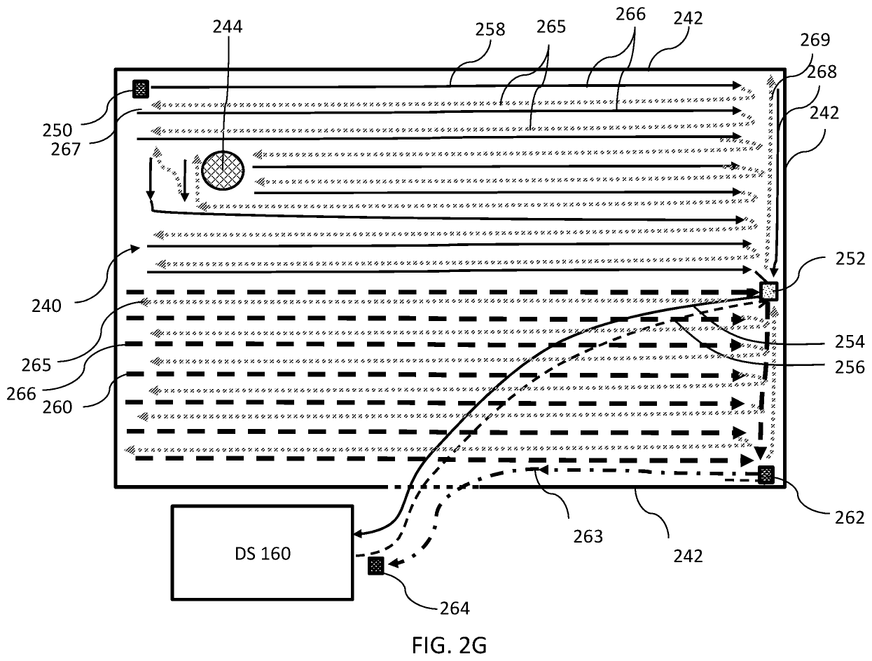

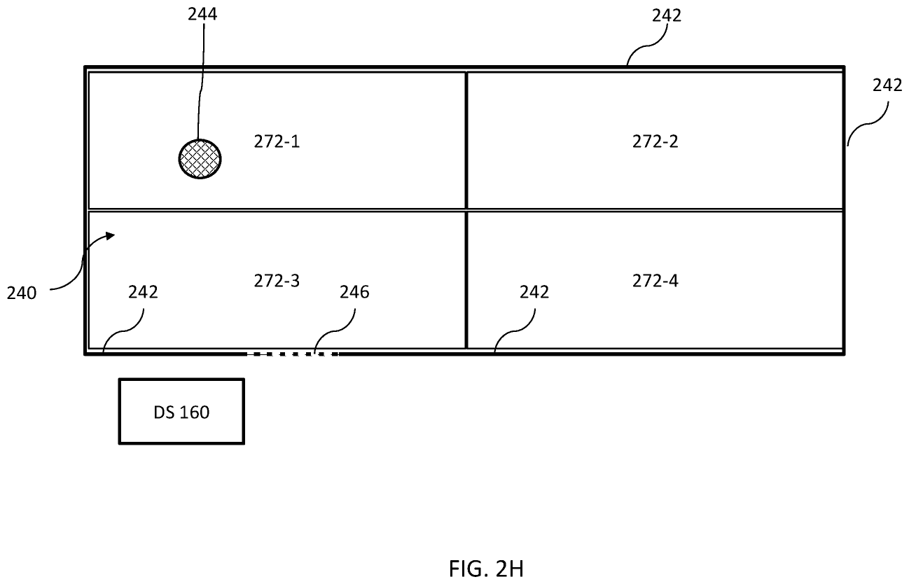

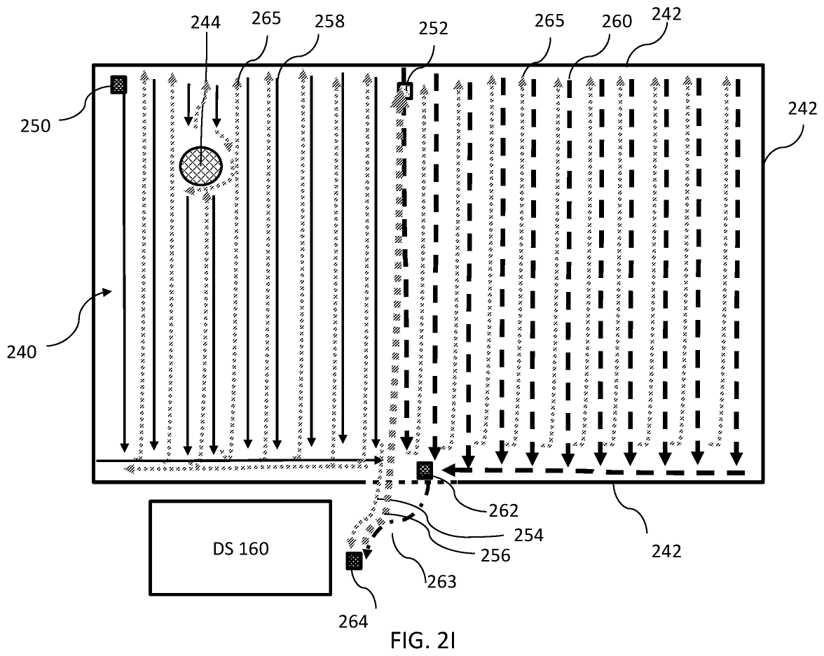

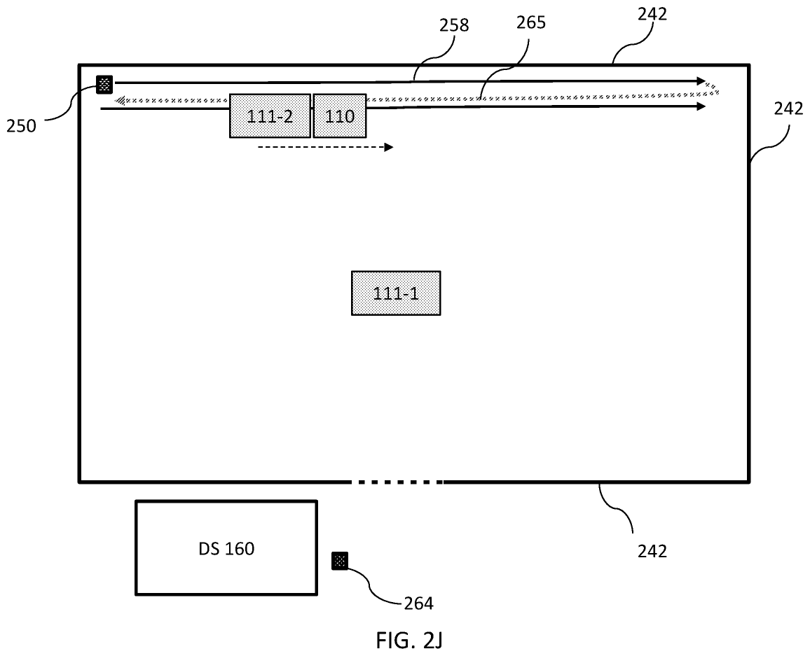

FIGS. 2A and 2B-2J are respectively a flowchart and illustrative floorplans showing operation of an automated floor laying system according to some embodiments. FIG. 2A shows process 200 that is performed using floor laying system 100 as described above. The steps below are described with reference to a computing device that performs operations described at each step unless specified otherwise. The computing device can correspond to a computing device corresponding to controllers 120 and/or 161. Where system 100 or FLR 110 or DS 160 may be said herein to provide specific functionality or perform actions, it should be understood that the functionality or actions are performed by controllers 120, 161 that may call on other components of system 100. Controllers 120 and 161 may manage the operation of the components of system 100 and may direct the flow of data between the components of system 100. Some steps require input or actions of human personnel operating system 100 as specified below.

The floorplans and points indicated thereon are provided for illustration and should not be considered limiting the use of system 100 to specific floorplans.

In step 202, system 100 is transported by personnel to a site where floor laying is required. DS 160 is connected to power and FLR 110 is docked in DS 160. In some embodiments, a single DS 160 may be provided along with multiple FLRs 110 to cover large areas or to speed up the floor coating process.

In step 204, the area where floor laying is planned may be mapped by system 100. Mapping may be initiated by deploying FLR 110 by interacting with FLR interface 118 or DS interface 163 to select a mapping mode and placing FLR 110 in the area 240 to be mapped. FLR 110 may move autonomously within area 240 and may map area 240 using data provided to controller 120 by mapping sensor 116 and/or cameras 122. In some embodiments, light source 117 may be activated as needed. The mapping process may detect the boundaries 242 of area 240 such as walls, stairs, and so forth. In some embodiments, FLR 110 may lay coated sections where boundaries 242 are defined by a section frame, where following laying, the laid sections are repositioned as work surfaces or wall coverings. Additionally, obstacles 244 such as pillars may also be mapped. Additionally, the gradients of surface 10 may be mapped. Additionally, uneven surfaces such as bumps and ridges may be mapped. In some embodiments, a virtual wall 246 may be deployed to define a virtual boundary of area 240 such as an opening. Virtual wall 246 may include a signal generator that mapping sensor 116 may identify as a virtual wall 246. In some embodiments, a dedicated mapping robot (not shown) may be deployed for mapping area 240.

In step 206, the laying mission may be defined based on the mapped-out area. System 110 is configured for listing options for and accepting mission-definition parameters provided by interaction by operating personnel with DS interface 163 and/or external device 190. The mission definition includes selecting/defining one or more of the following parameters and/or settings:
defining whether the entire mapped area is to be covered with coating material or only a sub-section and further definition of such a sub-section;
defining the type of coating material including the constituent materials required;
defining where the coating material will be mixed—in DS mixer 167 or in FLR mixer 159 depending on the type of coating material and the time between mixing and laying required;
defining the number of coatings required and the materials to be used for each coating;
defining whether polishing and cleaning are required before or between different materials laid on top of one another;
defining the height of coating desired;
defining whether correction of gradients of surface 10 is required and to what extent;
defining where correction of irregular surfaces (bumps or ridges) is required;
definition of special patterns or drawings and related materials;
defining the number of FLRs 110 to be deployed to complete the mission and the function of each FLR 110;
definition of use of attachment tools for specific tasks;
defining the target time to be taken for all parts of the mission including mixing, recharging, and laying;
defining the expected dry time of the surface coating based on measured temperature and humidity of the air and also the humidity of the surface. In some embodiments, one or both of DS 160 and/or FLR 110 include temperature and humidity sensors (not shown).

In step 208, the navigation plan (also referred to herein as the coating route), amount and types of coating materials needed, and charging (power and material) plan may be determined by DS controller 161 and/or FLR controller 120 taking into account the mission definitions provided in step 206. As shown in FIG. 2C, the determination may include one or more of the following coating route and associated parameters:
Determining a coating route that will cover the entire mission area without retracing a route so as not to damage laid coatings such as the exemplary routes 258 and 260 shown;
Determining the coating materials and amounts of coating materials required to be filled into DS 160 and the FLRs 110;
Determining where to start the coating route such as starting point 250;
Determining when in the coating route to recharge the coating material and/or battery of FLR 110 such as at exemplary point 252 where FLR 110 will return to DS 160 by route 254 for recharging of materials and then return via route 256 back to point 252 to continue the mission with second route 260. Point 252 is preferably positioned at the end of a laying strip so as to provide a more seamless continuation of route 260 from a new strip (as opposed to restarting in the middle of a strip);
Determining a coating route for coating around obstacles 244;
Determining where the end point of the coating route such as exemplary point 262 will be;
Determining where DS 160 is located;
Determining the number of FLRs 110 to be used (more than one may be serviced by the same docking station 160) so as to divide the area between them and prevent damaging of surfaces laid by a first FLR 110 by a further FLR 110 passing over these surfaces. In some embodiments, the area to be coated is divided between multiple FLRs 110. Alternatively multiple FLRs 110 may each lay one or more coatings for some or all of the area to be coated;
Determining the additional tools (such as those attached to attachment mount 180) needed for interim stages such as polishing, shoveling, or distributing additional material to create bespoke textures or patterns or finishes, smoothing and/or cleaning;
Determining whether and in which parts of area 240 additional coating materials are needed for leveling out gradients or correcting irregular surfaces. This determination may alternatively or additionally be performed by FLR 110 in real-time during the laying of a coating material.
Determining the speed of the FLR 110 in each part of the planned route to avoid damaging already-laid areas;

In step 210, FLR 110 may be docked with DS 160 for recharging of batteries 124 (if required) and for filling storage tanks 146 with mixed or unmixed coating materials as required. If required, tools for attachment mount 180 may be attached by operating personnel. DS 160 may then communicate the determined coating route and associated parameters to the one or more FLRs 110 (and charging robots 111 if deployed), that may then autonomously follow the coating route and associated parameters to thereby coat the surface.

In step 212, FLR 110 navigates to a starting point such as point 250 and lays coating material on surface 10 while moving in the determined route of step 208. Where required by the mission, FLR 110 may mix coating materials while deploying these using CAA 140. FLR 110 follows the determined routes of step 208 and uses mapping sensor 116 and/or cameras 122 providing data to controller 120 for positioning and navigation. In some embodiments, light source 117 may be activated as needed. FLR 110 uses the determined route of step 208 as well as real-time data from mapping sensor 116 and/or cameras 122 to avoid obstacles such as workers or other FLRs 110. FLR 110 may communicate activity and status in real time with DS controller 161 using comms 115 and comms 162. External device 190 may also monitor the status and progress of FLR 110. In some embodiments, external device 190 or DS interface 163 may be used to manipulate FLR 110 such as by changing the determined route.

FLR 110 may use CAA 140 to coat surface 10 using a coating material 20 (as shown in FIG. 1J). As FLR 110 moves over surface 10, FLR 110 may make use of data from cameras 122 and mapping sensor 116 to detect uneven, non-level, or irregular portions of surface 10 so as to determine in real time (during the coating process) by controller 120 adjustments to one or more of the following parameters to ensure that the final coated surface is even and level:
the amount of coating material 20 (FIG. 1J) deployed;
the speed of pouring and spreading;
the speed of FLR 110 or the speed of individual wheels;
the height of spreader roller 142 above the surface.

FLR 110 may also adjust the amount of coating material dispersed to compensate for gradient changes of surface 10. FLR 110 may turn against boundaries 242 placing edge side 143 of spreader roller 142 against boundaries 242 to ensure that the coating material 20 is evenly applied against boundaries 242 and in corners. Optionally, prior to laying a first layer of coating material, FLR 110 may follow, for example, routes 258 and 260 to prepare surface 10 such as by polishing, cleaning, or vacuuming, by using an appropriate tool attached to attachment mount 180. Optionally, prior to laying a first layer of coating material, FLR 110 may follow, for example, routes 258 and 260 to clean surface 10 such as by using a cleaning/vacuuming tool attached to attachment mount 180.

It should be appreciated that step 212 is performed by FLR 110 autonomously without the need for manual intervention thus overcoming the errors and inefficiencies of a human, manual coating process. It should be appreciated that FLR 110 may make adjustments to the determined route of step 208 such as to avoid obstacles or compensate for surface irregularities in real time. FLR 110 may be in data communication with DS 160 during coating and may report the status, position, and coating material levels to DS 160 periodically or continually.

In step 214, having completed route 258 and coated all of area 270, FLR 110 may reach a planned recharging point 252 and may navigate by route 254 back to DS 160 for recharging of materials and or batteries. Steps 210 and 212 may now be repeated and as shown in FIG. 2E, FLR 110 navigates back to recharging point 252 via route 256 to seamlessly continue laying coating material 20 until second route 260 is completed and end point 262 is reached. Alternatively, a second FLR 110 charged from the same DS 160 now navigates to recharging point 252 via route 256 to seamlessly continue laying coating material 20 until second route 260 is completed and end point 262 is reached, following which, FLR 110 returns to DS 160 via route 263.

Steps 210 to 214 may be repeated for each additional layer of coating material required as defined in the mission of step 206 and the plan of step 208. Additionally or optionally, between layers of coating materials FLR 110 may follow routes 258 and 260 to polish, clean, grind down or otherwise process coated surface 10 such as by using tools that are attached to attachment mount 180 in step 210. Optionally, polishing, cleaning and other steps may be provided by one or more additional FLRs 110.

A non-limiting example of the processes performed using system 100 for a typical floor application mission may include: preparing surface 10 by polishing, sanding, and cleaning; laying of a primer coating material; polishing and cleaning; laying of a first coating material; polishing and cleaning; laying of a second coating material; laying of a sealer; polishing and cleaning. It should be appreciated that use of a single FLR 110 for all of these processes reduces the tools and machinery that need to be acquired, brought to site, and maintained.

In step 216, as shown in FIG. 2F, FLR 110 may navigate to end point 264 at DS 160. In step 218, after docking with DS 160, FLR 110 may be cleaned by DS 160 by removal of unused materials from FLR 110 and injection of cleaning materials into FLR 110 and running of cleaning processes on FLR 110. DS 160 may then be cleaned using automated processes.

Optionally, after cleaning, in decision step 220, the mission of step 206 and the plan of step 208 may be reviewed by FLR 110 and DS 160 to determine whether another layer of coating material or other activity is required by FLR 110. If so, then steps 210 to 214 may be repeated for additional layers of coating material required as defined in the mission of step 206 and the plan of step 208. Additionally or optionally, between layers of coating materials, FLR 110 may follow routes 258 and 260 to polish, clean, grind down or otherwise process coated surface 10 such as by using tools attached to attachment mount 180.

FIGS. 2G-2J illustrate alternative coating routes that may be followed by one or more FLRs 110 within process 200. It should be appreciated that any suitable combination of the illustrated routes in FIGS. 2C-2J may be utilized according to one or more of the surface coating needs, nature of the area and surface to be coated, type of material or coating activity, capabilities of FLR 110 and number of FLRs 110 deployed.

As shown in FIG. 2G, in some embodiments, FLR 110 may lay coating material in a first direction 266 and then return to an adjacent uncoated point 267 via route 265 in a second direction while not laying any coating material. Laying routes 266 and non-laying reverse route 265 may then be repeated until FLR 110 reaches point 252. In some embodiments, FLR 110 may traverse the second direction in reverse, without turning around. In some embodiments, FLR 110 may need to perform a surface edge coating along a route 268, and then traverse a reverse route 269 while not performing any coating.

FIG. 2H shows an exemplary division of an area 240 that may be coated by multiple FLRs 110 coating a surface. Each FLR 110 may be allocated a coating region 272 for coating. Four such regions 272-1 . . . 272-4 are shown by way of example. Within each coating region 272, each FLR 110 follows routes such as shown in FIGS. 2C, 2G, or 2I. The division of an area 240 into coating regions 272 may for example be determined by DS 160 as part of the route planning of step 208.

FIG. 2I shows an exemplary route taken by an FLR 110 to coat an area 240. In the embodiment of FIG. 2I, an FLR 110 may traverse a shorter dimension (typically termed the width) of an area 240 for coating and/or non-coating (265), as opposed to traversing a longer dimension (typically termed the length) of an area 240 such as in the exemplary routes of FIGS. 2C and 2G. Such as route determination (by DS 160) may for example be made due to fast drying times of the coating material used and the need to coat overlapping strips within a shorter time than would be available if the longer dimension of area 240 was used.

FIG. 2J illustrates exemplary use of a charging robot 111 while an FLR 110 is coating a surface. In some embodiments, charging robot 111 (here shown as 111-1) may be stationary within area 240 to reduce the travel time of FLR 110 to refill/recharge from charging robot 211 (as opposed to travelling to DS 160 for refill/recharge). In some embodiments, charging robot 111 (here shown as 111-2) may follow FLR 110 for continually refilling and/or recharging FLR 110 as FLR 110 moves and lays a floor coating. In some embodiments, charging robot 111 (here shown as 111-2) may follow FLR 110 for periodically refilling and/or recharging FLR 110 as FLR 110 lays a floor coating. In some embodiments, charging robot 111 may perform floor-laying functionality in addition to supporting FLR 110.

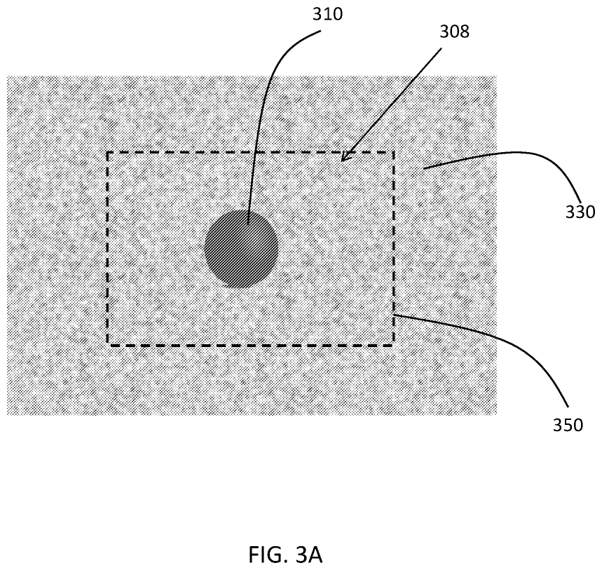

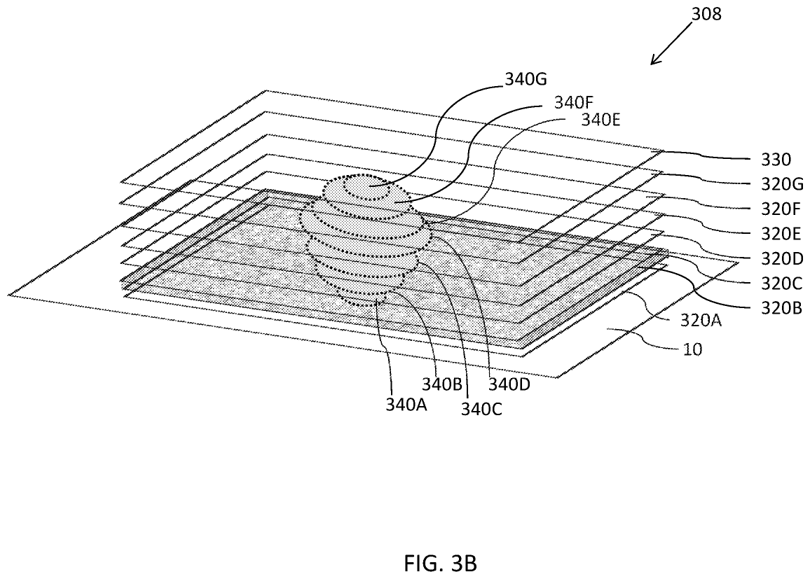

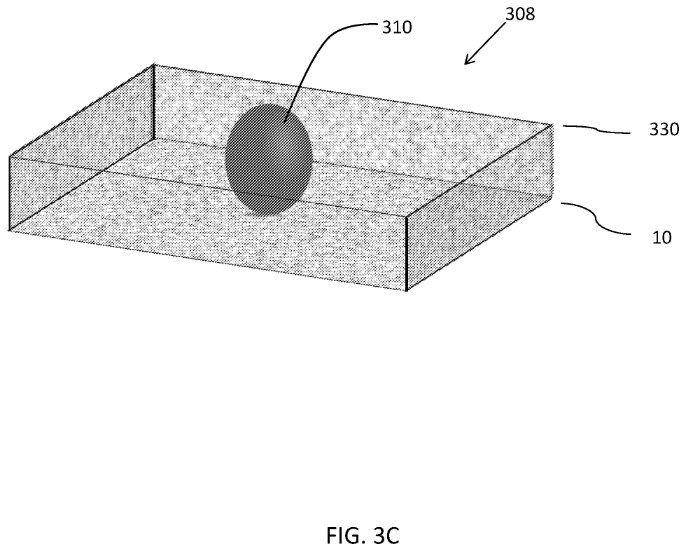

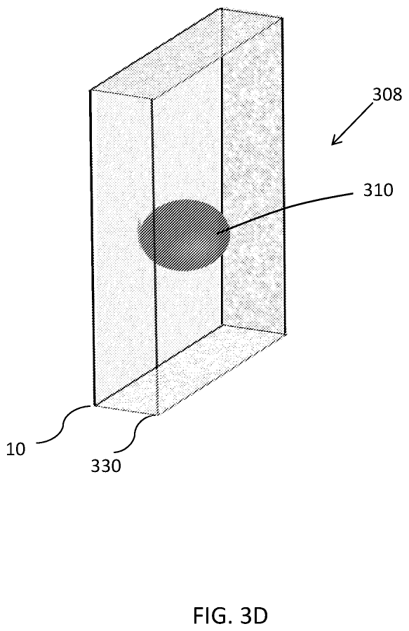

Reference is now made to FIGS. 3A-3D illustrating a method for printing a layered resin 3D floor or wall coating according to some embodiments. The steps below are described with reference to a computing device that performs operations described at each step unless specified otherwise. The computing device can correspond to a computing device corresponding to controllers 120 and/or 161. Where system 100 or FLR 110 or DS 160 may be said herein to provide specific functionality or perform actions, it should be understood that the functionality or actions are performed by controllers 120, 161 that may call on other components of system 100.

As shown in FIG. 3A, a layered resin cuboid 308 may include an image 310 embedded into a surface 330 such that the image 310 appears to have 3D depth within surface 330 while surface 330 remains flat. Although a cuboid 308 is described herein, it should be appreciated that any layered shape may be formed, and the use of the term cuboid herein refers to any other shape as well. The effect may be achieved by laying layers 320 of a coating material interspersed with painted layers 340 that represent image 310 in a 3D form to form surface 330. In some embodiments, the coating material may be a resin.

In some embodiments, surface 330 including layers 320 and 340 may be laid using FLR 110 and process 200 as described above, with image 310 painted by FLR 110 to appear embedded in the laid surface 330. In some embodiments, FLR 110 is provided with a duplicated CAA 140 enabling FLR 110 to lay two materials alternately or concurrently. In the case of the printed cuboid a first CAA 140 connected to first storage tank 146 may lay a clear or partially clear coating materials based on a resin, and a second CAA 140 connected to a second storage tank 146 may lay an ink or other multicolor material. In some embodiments, FLR 110 uses valves 157 alternately to lay two materials alternately or concurrently. In the case of the printed cuboid a first valve 157 connected to first storage tank 146 may lay a clear or partially clear coating materials based on a resin, and a second valve 157 connected to a second storage tank 146 may lay an ink or other multicolor material.

Cuboid 308 may be laid in a frame 350. Following completion of laying of the layered resin, frame 350 may be removed or alternatively remains surrounding cuboid 308. In some embodiments, frame 350 may be formed by boundaries 242 and/or 246. Cuboid 308 may be laid horizontally and positioned as part of a floor such as shown in FIG. 3C or alternatively may be laid horizontally and then turned vertically to form part of a wall such as shown in FIG. 3D.

In a planning step, image 310 may be divided into printing layers such as by a software algorithm running on a computer or on DS 160 or on FLR 110. As shown in FIG. 3B, image 310 is split into 7 layers 320 but this should not be considered limiting as any suitable number of layers 320 may be used depending on the desired 3D effect and the height of surface 330. Cuboid 308 may be laid on substrate surface 10.

In some embodiments, after initial cleaning of surface 10, a wax or other nonstick material may be laid before applying the first layer 320A of resin by FLR 110. The first layer 320A of resin may be applied evenly across the surface 10. Alternatively, first layer 320A may be a coating material other than a resin. Following laying and setting of resin layer 320A, a first painted layer 340A representing the “lowest” part of image 310 may be painted onto resin layer 320A by FLR 110. In some embodiments, each painted layer 340 may include resin laid by a first CAA 140 of FLR 110 and ink or other colored material laid by a second CAA 140 of FLR 110. In some embodiments, each painted layer 340 may include resin laid through a first valve 157 of CAA 140 and ink or other colored material laid through a second valve 157 of CAA 140 of FLR 110. Following painting and setting of painted layer 340A, another resin layer 320B may be laid on top of painted layer 340A by FLR 110. In some embodiments, where the resin image process may be performed by FLR 110, FLR 110 holds both of the resin and paint in separate storage tanks 146. Alternatively, painting may be performed by a painting tool attached to attachment mount 180. Alternatively, a first FLR 110 lays the resin layers 320 and a second FLR 110 paints the paint layers 340.

In some embodiments, curing of resin layers 320 may be performed by heating or UV exposure of the most recently laid resin layer 320 such as by use of heating or UV attachment tools attached to mount 180. In some embodiments, every already-set resin layer 320 may be polished and/or vacuumed by FLR 110 with a suitable attachment.

This layering process may be performed repeatedly for every resin layer 320 and painted layer 340 until completion of the uppermost painted layer here shown as 340G. A final surface layer 330 may then be laid using resin, a sealer coating or other finish coating. In some embodiments, each resin layer 320 may be up to 1 cm thick.

Unless otherwise defined, all technical and scientific terms used herein have the same meaning as commonly understood by one of ordinary skill in the art. The materials, methods, and examples provided herein are illustrative only and not intended to be limiting.

As used herein the terms “machine learning” or “artificial intelligence” or “machine vision” refer to use of algorithms on a computing device that parse data, learn from the data, and then make a determination or generate data, where the determination or generated data is not deterministically replicable (such as with deterministically oriented software as known in the art).

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a chip or a circuit. As software or algorithm, selected steps of the disclosure could be implemented as a plurality of software instructions being executed by a computer using any suitable operating system. In any case, selected steps of the method and system of the disclosure could be described as being performed by a data processor, such as a computing device for executing a plurality of instructions.

As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may form a “network” or a “computer network”.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and/or touchscreen and/or a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

It should be appreciated that the above-described methods and apparatus may be varied in many ways, including omitting or adding steps, changing the order of steps and the type of devices used. It should be appreciated that different features may be combined in different ways. In particular, not all the features shown above in a particular embodiment or implementation are necessary in every embodiment or implementation of the invention. Further combinations of the above features and implementations are also considered to be within the scope of some embodiments or implementations of the invention.

While certain features of the described implementations have been illustrated as described herein, many modifications, substitutions, changes, and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While the disclosure has been described with respect to a limited number of embodiments, it will be appreciated that many variations, modifications, and other applications of the disclosure may be made.

1. An automated coating material laying system comprising:
a floor laying robot (FLR) configured to lay a coating material on a floor; and
a docking station (DS) configured to fill the FLR with the coating material for use by the FLR for coating the floor.

2. The system of claim 1, wherein the configuration for laying a coating material includes detecting by the FLR of uneven parts of the floor and determining appropriate application of the coating material to ensure a levelled out coated floor.

3. The system of claim 2, wherein the FLR includes one or more cameras for providing visual data for detection of uneven parts of the floor.

4. The system of claim 1, wherein the FLR includes a mapping sensor configured to provide data for performing simultaneous localization and mapping in a floor area to be coated.

5. The system of claim 4, wherein the mapping sensor includes one or more of a LIDAR sensor, ultrasound sensor, laser scanner, laser range finder, RADAR, 3D camera, time of flight sensor, scattered light sensor, 2D camera, ultrasound beacons, optical beacons, radio beacons, laser positioning systems, theodolites, GPS, Ultra-Wide Band (UWB) sensor, and optical flow sensor.

6. The system of claim 1, further comprising a coating application assembly (CAA) for distributing and spreading the coating material.

7. The system of claim 6, wherein the CAA includes a spreader roller positioned such that an edge side of the spreader roller is near flush with the edge of the FLR for spreading and rolling of the coating material against the edges of the floor.

8. The system of claim 1, wherein the FLR includes wheels and the wheels include spikes.

9. The system of claim 1, wherein the coating materials include one or more of: epoxies, urethanes, polyaspartics, methyl methacrylates (MMA), microtopping, micro-cement, primers, sealers, decorative overlays, cement screeds, paint, vinyl esters, and polymer floor coatings.

10. The system of claim 1, further including an attachment mount for attached tools.

11. The system of claim 10, wherein the attached tools include one or more of: a roller, a spike roller, serrated squeegee, squeegee, plastering-trowel, magic trowel, concrete helicopter, an ultraviolet (UV) light, a polisher, and a vacuum cleaner.

12. The system of claim 1, further including a charging robot configured to refill the FLR with coating materials and/or to recharge the FLR.

13. The system of claim 12, wherein the charging robot is configured to follow the FLR and to refill and/or charge the FLR continually while the FLR is performing floor coating.

14. The system of claim 1, wherein the DS is configured to determine a coating route to be followed by the FLR to lay a coating material on the floor in an area.

15. The system of claim 14, wherein the DS is further configured to determine one or more of: the coating materials and amounts of coating materials required to be filled into the FLRs, where in the area to start the coating process, when to refill the coating material in the FLR, a coating route for coating around an obstacle, the end point of the coating process, the number of FLRs required, where additional coating materials are needed for leveling out gradients or correcting irregular surfaces, and/or the speed of the FLR in each part of the coating route.

16. The system of claim 14, wherein the coating route includes traversing an area by the FLR while laying the coating material, interspersed with a reverse traversal during which no coating material is laid.

17. A method for laying a coating material on a floor comprising:
providing a floor laying robot (FLR);
providing a floor coating mission to the FLR; and
activating the FLR for completing the floor coating mission.

18. The method of claim 17, further comprising detection by the FLR of uneven parts of the floor and determining appropriate application of the coating material to ensure a levelled out coated floor.

19. The method of claim 18, wherein the FLR comprises one or more cameras for providing visual data for detection of uneven parts of the floor.

20. The method of claim 17, further comprising, performing simultaneous localization and mapping in a floor area to be coated by the FLR.

21. The method of claim 17, further comprising distributing and spreading a coating material on the floor by the FLR.

22. The method of claim 21, further comprising spreading and rolling of coating material against edges of the floor.

23. The method of claim 22, wherein the coating materials include one or more of: epoxies, urethanes, polyaspartics, methyl methacrylates (MMA), microtopping, micro-cement, primers, sealers, decorative overlays, cement screeds, paint, vinyl esters, and polymer floor coatings.

24. The method of claim 17, further comprising providing on the FLR an attachment mount for attached tools.

25. The method of claim 24, wherein the attached tools include one or more of: a roller, a spike roller, serrated squeegee, squeegee, plastering-trowel, magic trowel, concrete helicopter, an ultraviolet (UV) light, a polisher, and a vacuum cleaner.

26. The method of claim 17, further comprising, by a charging robot, refiling the FLR with coating materials and/or recharging the FLR.

27. The method of claim 17, further comprising, by the charging robot, following the FLR to refill and/or charge the FLR continually while the FLR is performing floor coating.

28. The method of claim 17, further comprising, providing a docking station (DS), and by the DS, determining a coating route to be followed by the FLR to lay a coating material in an area.

29. The method of claim 28, wherein the DS is further configured to determine one or more of the coating materials and amounts of coating materials required to be filled into the FLRs, where in the area to start the coating process, when to refill the coating material in the FLR, a coating route for coating around an obstacle, the end point of the coating process, the number of FLRs required, where additional coating materials are needed for leveling out gradients or correcting irregular surfaces, and/or the speed of the FLR in each part of the coating route.

30. The method of claim 28, wherein the coating route includes traversing an area by the FLR while laying a coating material, interspersed with a reverse traversal during which no coating material is laid.

31-38. (canceled)
